(19) United States
(12) Patent Application Publication
(10) Pub. No.: US 2020/0019543 A1
(43) Pub. Date: Jan. 16, 2020

(54) METHOD, APPARATUS AND DEVICE FOR UPDATING DATA, AND MEDIUM

(71) Applicant: BEIJING BAIDU NETCOM SCIENCE AND TECHNOLOGY CO., LTD., Beijing (CN)

(72) Inventor: Tianyu WANG, Beijing (CN)

(21) Appl. No.: 16/508,022

(22) Filed: Jul. 10, 2019

(30) Foreign Application Priority Data
Jul. 11, 2018 (CN) 201810758664.2

(51) Int. Cl. G06F 16/23; G06F 9/38; G06F 16/27

(52) U.S. Cl. CPC G06F 16/2379; G06F 16/275; G06F 9/3836

(57) ABSTRACT

Embodiments of the present disclosure relate to a method, apparatus, and device for updating data, and a medium. The method includes: sending a to-be-updated event to at least one slave; and controlling a local database to update the to-be-updated event, and synchronously issuing an update instruction to the at least one slave, where the update instruction is used for instructing the at least one slave to synchronously update the received to-be-updated event.

### CROSS-REFERENCE TO RELATED APPLICATIONS

This application claims priority to Chinese Patent Application No. 201810758664.2, filed on Jul. 11, 2018, titled “Method, apparatus and device for updating data, and medium,” which is hereby incorporated by reference in its entirety.

### TECHNICAL FIELD

Embodiments of the present disclosure relate to the field of a relational database management system (MySQL) and particularly to a method, apparatus and device for updating data, and a medium.

### BACKGROUND

With the explosive growth of Internet data, a database, as a storage medium of the Internet data, carries increasingly more data and meets increasingly more data access requests. Particularly, in a financial business scenario, the database is requested to achieve high reliability of data (i.e., strongly consistent distribution), or otherwise will result in capital losses of business or even stop services.

Referring to FIG. 1, the process of synchronously updating data between a master (i.e., master database) and a slave (i.e., slave database) of a MySQL may be generally described as: when event updating occurs, a master in a database cluster first writes a to-be-updated event into a binary log (binlog) based on write-ahead-logging (WAL); then replicates the completed binlog of the to-be-updated event to a relaylog of at least one slave, and returns a user response; at least one slave updates the slave based on the binlog of the to-be-updated event, so that data in the at least one slave stay consistent with data in the master; and after completing writing the to-be-updated event into the binlog, the master will commit the event.

However, after the master completes writing the to-be-updated event into the binlog, and before the master replicates the completed binlog of the to-be-updated event to a slave, if abnormal shutdown or communication failure of the device of the master occurs, then after restart or failure recovery of the device of the master, the master will commit the event directly based on the completed binlog. However, at this time, the completed binlog of the to-be-updated event is not replicated to the slave. Therefore, the slave cannot perform corresponding data updating, resulting in data inconsistency between the slave and the master.

Moreover, MySQL authority makes optimization merely between user visibility (reflected as returning a user response) and data synchronizing result in semi-synchronous and non-destructive semi-synchronous replication mechanisms, but still fails to guarantee that a committed event is certainly synchronized to a slave.

A typical case is that in a transaction scenario, after payment process completes deducting money in the master, the master failure prevents from updating the money deduction record to a slave in the database cluster. Therefore, the money is deducted, but the user cannot read the money deduction record from the slave, thereby resulting in stopping business services.

### SUMMARY

Embodiments of the present disclosure provide a method, apparatus and device for updating data, and a medium to achieve synchronous data updating of a slave and a master.

In a first aspect, an embodiment of the present disclosure provides a method for updating data. The method includes: sending a to-be-updated event to at least one slave; and controlling a local database to update the to-be-updated event, and synchronously issuing an update instruction to the at least one slave, the update instruction instructing the at least one slave to synchronously update the received to-be-updated event.

The embodiment of the present disclosure first sends, before a master performs updating on a to-be-updated event, the received to-be-updated event to at least one slave, to solve a problem that after the master completes writing the to-be-updated event into a binlog, and before the master replicates the completed binlog of the to-be-updated event to a slave, abnormal shutdown or communication failure of the device of the master occurs, so that the slave cannot receive the to-be-updated event, nor can the slave update data based on the to-be-updated event.

Moreover, the slave updating the received to-be-updated event is triggered by updating the to-be-updated event in the master, thereby achieving synchronously updating the to-be-updated event in the master and the slave, and guaranteeing to keep data consistency between the slave and the master.

In a second aspect, an embodiment of the present disclosure further provides a method for updating data. The method includes: storing a received to-be-updated event in a local disk or hard disk; and updating data on a local database based on the received to-be-updated event if receiving an update instruction issued by a master.

The embodiment of the present disclosure stores a received to-be-updated event in a local disk or hard disk, thereby achieving persistence of the to-be-updated event, and avoiding data loss of the to-be-updated event resulted from device shutdown or restart. Furthermore, after receiving an update instruction issued by a master, data updating on a local database is performed based on the received to-be-updated event, thereby achieving synchronous data updating with the master.

In a third aspect, an embodiment of the present disclosure further provides an apparatus for updating data. The apparatus includes: an event sending module configured to send a to-be-updated event to at least one slave; and an event committing module configured to control a local database to update the to-be-updated event, and synchronously issue an update instruction to the at least one slave, where the update instruction instructing the at least one slave to synchronously update the received to-be-updated event.

In a fourth aspect, an embodiment of the present disclosure further provides an apparatus for updating data. The apparatus includes: a persisting module configured to store a received to-be-updated event in a local disk or hard disk; and a data updating module configured to update data on a local database based on the received to-be-updated event if receiving an update instruction issued by a master.

In a fifth aspect, an embodiment of the present disclosure further provides a device. The device includes: one or more processors; and a storage apparatus configured to store one or more programs, where the one or more programs, when executed by the one or more processors, cause the one or more processors to implement the method for updating data according to any one of the embodiments of the present disclosure.

In a sixth aspect, an embodiment of the present disclosure further provides a computer readable storage medium, storing a computer program thereon, where the program, when executed by a processor, implements the method for updating data according to any one of the embodiments of the present disclosure.

### BRIEF DESCRIPTION OF THE DRAWINGS

FIG. 1 is a signaling diagram of data updating between a master and a slave in the prior art;

FIG. 2 is a flowchart of a method for updating data provided in a first embodiment of the present disclosure;

FIG. 3 is a flowchart of a method for updating data provided in a second embodiment of the present disclosure;

FIG. 4 is a flowchart of a method for updating data provided in a third embodiment of the present disclosure;

FIG. 5 is a signaling diagram of data updating between a master and a slave provided in a fourth embodiment of the present disclosure;

FIG. 6 is a schematic diagram of data flow transmission between threads within a database provided in a fourth embodiment of the present disclosure;

FIG. 7 is a schematic diagram of control flow transmission between threads within the database provided in a fourth embodiment of the present disclosure;

FIG. 8 is a schematic structural diagram of an apparatus for data updating provided in a fifth embodiment of the present disclosure;

FIG. 9 is a schematic structural diagram of an apparatus for data updating provided in a sixth embodiment of the present disclosure; and

FIG. 10 is a schematic structural diagram of an apparatus provided in a seventh embodiment of the present disclosure.

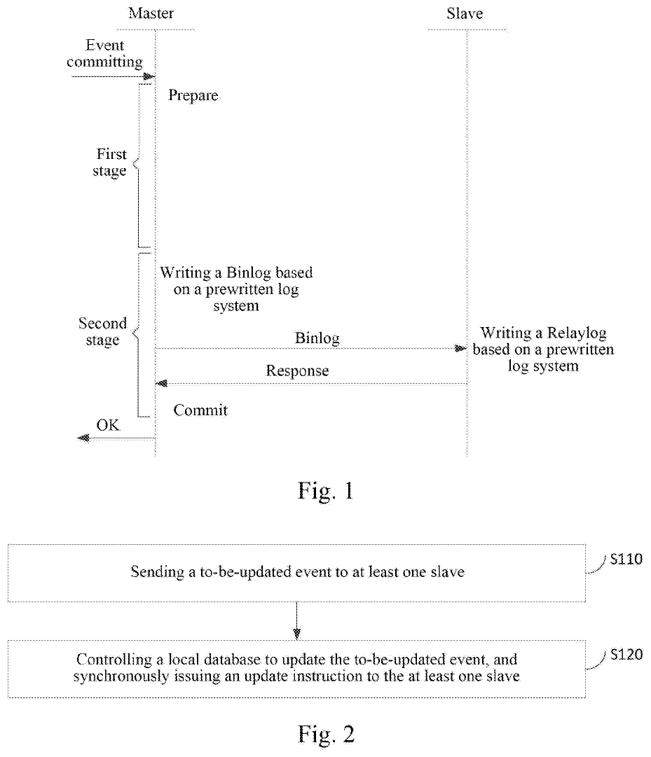

### DETAILED DESCRIPTION OF EMBODIMENTS

The present disclosure will be further described below in detail in combination with the accompanying drawings and the embodiments. It should be appreciated that the specific embodiments described herein are merely used for explaining the present disclosure, rather than limiting the present disclosure. In addition, it should be noted that, for the ease of description, only the parts related to the relevant disclosure are shown in the accompanying drawings.

### The First Embodiment

FIG. 2 is a flowchart of a method for updating data provided in the first embodiment of the present disclosure. The present embodiment may be applied to a case in which data is update in a database cluster. The method may be performed by an apparatus for updating data. The apparatus may be implemented by means of software and/or hardware, and is provided in association with a master database. Referring to FIG. 2, the method for updating data provided in the present embodiment includes the following steps.

S110, sending a to-be-updated event to at least one slave.

The slave is a simplified name for the slave database, which refers to data except for the master database in a database cluster.

In general, a database cluster includes a master database and at least one slave database. A client sends a to-be-updated event to the master database. The master database writes the to-be-updated event into a binlog to implement data updating based on the to-be-updated event. After the master database completes data updating, the slave database updates data based on the to-be-updated event written by the master database into the binlog, thereby achieving data synchronization in the master database and the slave database.

Alternatively, acquiring the to-be-updated event may be implemented by an agent (self-active software or hardware entity) or by a thread.

Specifically, the sending a to-be-updated event to at least one slave includes: acquiring the to-be-updated event from a master work thread in a same progress via a master service thread by shared memory, and sending the to-be-updated event to the at least one slave via the master service thread.

Because the master service thread and the master work thread are in the same progress, the master service thread may acquire the to-be-updated event from the master work thread by shared memory. Because the agent needs to read the to-be-updated event from a local memory, compared with the acquiring the to-be-updated event by an agent, acquiring the to-be-updated event by shared memory among threads may avoid the trouble of reading the to-be-updated event from the local memory, thereby reducing communication costs.

Another cause is that the states of threads in the same progress are bound. If one fails, then all fail, and there will not be a phenomenon of partial failure, thus saving the cost of maintenance on partial failure.

S120, controlling a local database to update the to-be-updated event, and synchronously issuing an update instruction to the at least one slave.

The update instruction is used for instructing the at least one slave to synchronously update the received to-be-updated event.

The local database is a master database (hereinafter referred to as master) in the database cluster. The master writes the to-be-updated event into a binlog, thereby achieving data updating on the master based on the to-be-updated event.

Whilst updating data in the master based on the to-be-updated event, the update instruction is issued to the at least one slave, to implement synchronous updating of the master and the slave, and avoid occurrence of data inconsistency between the master and the slave.

After completing writing the to-be-updated event into the binlog, the master commits the event.

The technical solutions of the embodiments of the present disclosure first send, before a master performs updating on a to-be-updated event, the received to-be-updated event to at least one slave, to solve a problem that after the master completes writing the to-be-updated event into a binlog, and before the master replicates the completed binlog of the to-be-updated event to a slave, abnormal shutdown or communication failure of the device of the master occurs, so that the slave cannot receive the to-be-updated event, nor can the slave update data based on the to-be-updated event.

Moreover, the slave updating the received to-be-updated event is triggered by updating the to-be-updated event in the master, thereby achieving synchronously updating the to-be-updated event in the master and the slave, and guaranteeing data consistency between the slave and the master.

In order to guarantee a majority of slaves to receive the to-be-updated event, a trigger condition of the controlling a local database to update the to-be-updated event, and synchronously issuing an update instruction to the at least one slave is that: the number of received receipt acknowledgment messages is greater than a set acknowledgment threshold, where each slave returns a receipt acknowledgment message after receiving the to-be-updated event.

In order to solve a problem that after completing partition or failure recovery of the local database, the local database updates data directly based on the to-be-updated event sent by a client without sending the to-be-updated event to a slave, resulting in failure to update data on the to-be-updated event by the slave, the method further includes the following steps before the controlling a local database to update the to-be-updated event, and synchronously issuing an update instruction to the at least one slave: rolling back the to-be-updated event if detecting partition or failure of the local database.

The rolling back is to delete updating of event execution completed by one or more portions. In other words, the rolling back here may also be understood as deleting the to-be-updated event.

### The Second Embodiment

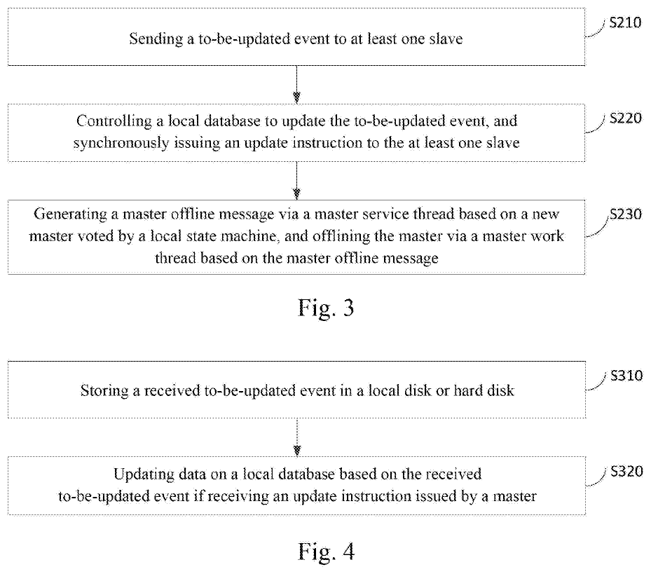

FIG. 3 is a flowchart of a method for updating data provided in second embodiment of the present disclosure. The present embodiment is an alternative scheme presented based on the above embodiments. Referring to FIG. 3, the method for updating data provided in the present embodiment includes the following steps.

S210, sending a to-be-updated event to at least one slave.

S220, controlling a local database to update the to-be-updated event, and synchronously issuing an update instruction to the at least one slave.

S230, generating a master offline message via a master service thread based on a new master voted by a local state machine, and offlining the master via a master work thread based on the master offline message.

Generally, the new master is voted by a third-party module, and the third-party module will send the voted new master to each database, so that the each database performs the switching between the master and the slave. In case of communication network failure of the third-party module and the local master, the local master does not receive a new master message sent by the third-party module, nor will the local master offline the master. However, the new master will perform master onlining based on the received new master message sent by the third-party module, resulting in occurrence of a circumstance where there are two masters (i.e., the new master successfully comes online, while the former master fails to go offline).

However, the present embodiment generates the master offline message via the master service thread based on the new master voted by the local state machine, and offlines the master via the master work thread based on the master offline message. Because there is no influence of communication network failure between the threads, data transmission between the threads will hardly have a problem of unreachable messages, thereby guaranteeing each database to receive the new master message, and avoiding occurrence of the circumstance where there are two masters.

In addition, there may be two masters in an interval time window during which the master service thread sends the master offline notification to the master work thread. However, after receiving to-be-updated information sent by the former master (i.e., the master that should go offline), the master service thread of the former master will determine whether a current database is the new master in combination with the new master voted by the state machine, and if the current database is not the new master, the master service thread of the former master will return a message of write-in failure, so as not to perform a writing operation.

Thus, it can be seen that, even though there may be two masters, the former master cannot implement data updating after determining by the master service thread of the former master. Essentially, there is still one master. In addition, the interval time window during which the master service thread sends a master offline notification to the master work thread is short. The former master will offline the master when receiving the master offline notification.

It should be noted that, the present embodiment does not limit the execution sequence of S230, and alternatively, S230 may be executed prior to S210 or S220.

Specifically, a state machine voting for a new master includes the following steps: receiving a request for being a new master sent by a state machine associated with other database; responding with an approval message if data amount of to-be-updated events in the other database is greater than or equal to data amount of to-be-updated events in the local database, or otherwise responding with a disapproval message; and using a database obtaining a highest number of approval messages as the new master.

By comparing data amount of to-be-updated events in databases, a database with the largest data amount of to-be-updated events is voted as the new master. The goal is to ensure updating the to-be-updated event.

The technical solutions of the embodiments of the present disclosure generate the master offline message via the master service thread based on the new master voted by the local state machine, and offline the master via the master work thread based on the master offline message. Because there is no influence of communication network failure between the threads, data transmission between the threads will hardly have a problem of unreachable messages, thereby guaranteeing each database to receive the new master message, and avoiding occurrence of the circumstance where there are two masters.

### The Third Embodiment

FIG. 4 is a flowchart of a method for updating data provided in third embodiment of the present disclosure. The present embodiment may be applied to a case in which data is update in a database cluster. The method may be performed by an apparatus for updating data. The apparatus may be implemented by means of software and/or hardware, and is provided in association with a slave database. Referring to FIG. 4, a method for updating data provided in the present embodiment includes the following steps.

S310, storing a received to-be-updated event in a local disk or hard disk.

Alternatively, the to-be-updated event may also be stored in other local medium for long-term storage of data, besides the local disk or hard disk.

S320, updating data on a local database based on the received to-be-updated event if receiving an update instruction issued by a master.

Specifically, a relaylog is written based on the received to-be-updated event. Data updating is performed based on the completed relaylog.

The technical solutions of the embodiments of the present disclosure store a received to-be-updated event in a local disk or hard disk, thereby achieving persistence of the to-be-updated event, and avoiding data loss of the to-be-updated event resulted from device shutdown or restart. Furthermore, after receiving an update instruction issued by a master, data updating on a local database is performed based on the received to-be-updated event, thereby achieving synchronous data updating with the master.

Before the updating data on a local database based on the received to-be-updated event if receiving an update instruction issued by a master, the method further includes the following steps: controlling the local database to perform updating and event committing based on the to-be-updated event if partition or failure of the master occurs, and the local database is a voted candidate master; and switching the local database to a new master; or comparing with to-be-updated events in the new master to delete more to-be-updated events than to-be-updated events in the new master if partition or failure of the master occurs, and the local database is still a slave after voting.

Specifically, the candidate master controlling the local database to perform updating based on the to-be-updated event includes: the candidate master sends a local to-be-updated event to other database, and sends the update instruction to other database to instruct the other database to update data based on the to-be-updated event when the candidate master controls the local database to perform updating based on the to-be-updated event.

The local database is controlled to update data based on the to-be-updated event, thereby achieving updating on the to-be-updated event in the database. In addition, more to-be-updated events in the slave than to-be-updated events in the new master are deleted, to further guarantee data consistency between the master database and the slave database.

### The Fourth Embodiment

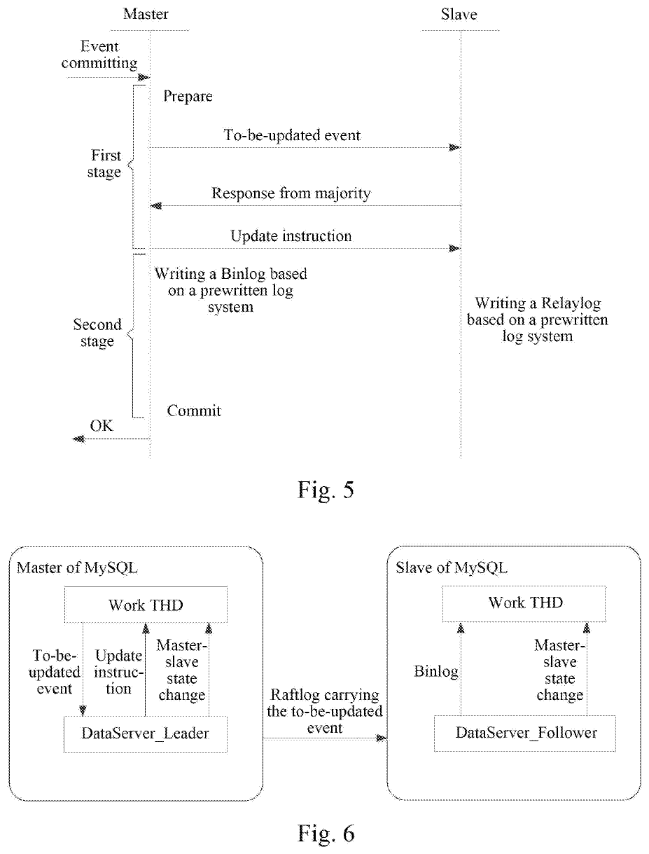

FIG. 5 is a flowchart of a method for updating data provided in the fourth embodiment of the present disclosure. The present embodiment is an alternative scheme presented based on the above embodiments. Referring to FIG. 5, the method for updating data provided in the present embodiment includes two stages.

Also referring to FIG. 6, a master service thread (DataServer_Leader) of a master acquires a to-be-updated event from a master work THD (i.e., the above master work thread) in a same progress by shared memory. Then, the DataServer_Leader writes the to-be-updated event in data of a message (RaftLog), and synchronizes the RaftLog to a DataServer_Follower of a slave using a majority rule approach.

After receiving the RaftLog, the DataServer_Follower persists the RaftLog, and returns a response to the DataServer_Leader.

After receiving responses returned from a majority of DataServer_Followers, the DataServer_Leader sends an update instruction to both the master work THD and the DataServer_Followers.

After receiving the update instruction, the master work THD writes the to-be-updated event into a binlog, and commits the event in the memory after completing writing the to-be-updated event into the binlog.

After receiving the update instruction, the DataServer_Followers extract content of the binlog from the RaftLog, write the extracted binlog into the relaylog by a synchronization thread of MySQL, and update data by a slave work THD.

Based on the above process, a corresponding relationship between event committing and data replication is guaranteed by the database service thread, i.e., when an event reaches a committing state, duplication of a majority of data must be completed.

In addition, compared with the traditional MySQL, a mutex problem in the process of generating and reading a binlog by data work THD and Dump thread is solved, thereby achieving mutex-free MySQL coordination and replication.

The above description provides data flow of database updating on the to-be-updated event.

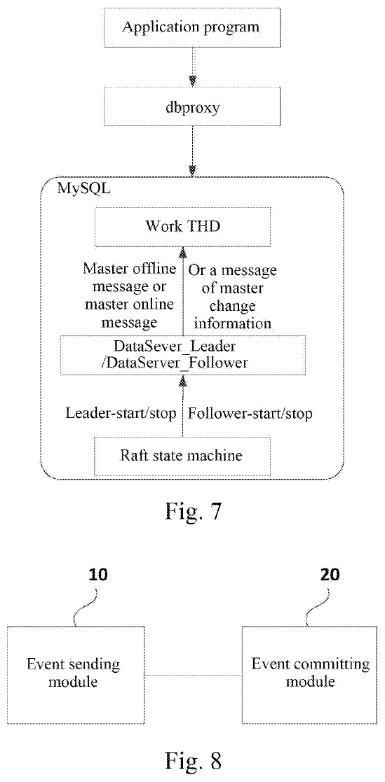

Referring to FIG. 6 and FIG. 7, in a scenario of switching between a master database and a slave database, control flow of the databases with data updating based on a to-be-updated event may be described as follows.

A proxy layer (dbproxy) acquires a master and a slave from a database cluster, and assigns a received to-be-processed event from an application client to the acquired master or the acquired slave.

The dbproxy is situated between the client and the databases. The to-be-processed event includes a reading event or a writing event. Generally, the reading event is assigned to the slave or the master, while the writing event is assigned to the master as a to-be-updated event for processing.

Database service thread acquires a leader-start/stop message and a follower-start/stop message from a Raft state machine. The database service thread generates a master offline message, a master online message, or a master change message based on the acquired leader-start/stop message and the acquired follower-start/stop message, and send the generated message to a database work THD, so that the database work THD responds with a corresponding message.

The voting mechanism for master is that: Raft voting for master drives databases to switch between a master and a slave, to avoid occurrence of a scenario where there are two masters. RAFT_Leader is used as MySQL_Master, while RAFT_Follower is used as MySQL_Slave.

The dbproxy actively senses a database state, to form a closed loop of state management, and achieve node state autonomy.

Where topological information of database nodes configures the management, and dbproxy of master-slave states of the database nodes performs the sensing dynamically.

The technical solutions of the embodiments of the present disclosure send, before a master writes a to-be-updated event into a binlog, the to-be-updated event to a slave, so that even when the master completes writing the binlog, but does not write the completed binlog into a relaylog of the slave, and abnormal shutdown of the device of the master occurs, the slave may still update data based on the received to-be-updated event, thereby achieving data consistency between the slave and the master.

The database service thread is introduced to solve a mutex problem in the process of generating and reading the binlog by data work THD and Dump thread, thereby achieving mutex-free MySQL coordination and replication.

Master offlining, master onlining, or master information changing are performed based on a master database voted by a Raft state machine, thus avoiding occurrence of a circumstance where there are two masters.

It should be noted that, based on technical teaching of the present embodiment, those skilled in the art would be motivated to combine schemes of any one implementation according to the above embodiments, to achieve synchronous data updating between a master database and a slave database.

### The Fifth Embodiment

FIG. 8 is a schematic structural diagram of an apparatus for data updating provided in the fifth embodiment of the present disclosure. Referring to FIG. 8, the apparatus for updating data provided in the present embodiment includes: an even sending module 10 and an event committing module 20.

The event sending module 10 is configured to send a to-be-updated event to at least one slave.

The event committing module 20 is configured to control a local database to update the to-be-updated event, and synchronously issue an update instruction to the at least one slave, where the update instruction is used for instructing the at least one slave to synchronously update the received to-be-updated event.

The technical solutions of the embodiments of the present disclosure first send, before a master performs updating on a to-be-updated event, the received to-be-updated event to at least one slave, to solve a problem that after the master completes writing the to-be-updated event into a binlog, and before the master replicates the completed binlog of the to-be-updated event to a slave, abnormal shutdown or communication failure of the device of the master occurs, so that the slave cannot receive the to-be-updated event, nor can the slave update data based on the to-be-updated event.

Moreover, the slave updating the received to-be-updated event is triggered by updating the to-be-updated event in the master, thereby achieving synchronously updating the to-be-updated event in the master and the slave, and guaranteeing to keep data consistency between the slave and the master.

Further, the event sending module includes: an event sending unit.

The event sending unit is configured to acquire the to-be-updated event from a master work thread in a same progress via a master service thread by shared memory, and send the to-be-updated event to the at least one slave via the master service thread.

Further, a trigger condition of the event committing module is that: the number of received receipt acknowledgment messages is greater than a set acknowledgment threshold, where each slave returns a receipt acknowledgment message after receiving the to-be-updated event.

Further, the apparatus further includes: an event rolling back module.

The event rolling back module is configured to roll back the to-be-updated event if detecting partition or failure of the local database before controlling a local database to update the to-be-updated event, and synchronously issuing an update instruction to the at least one slave.

Further, the apparatus further includes: a state machine voting module.

The state machine voting module is configured to generate a master offline message via the master service thread based on a new master voted by a local state machine, and offlining the master via the master work thread based on the master offline message.

Further, the state machine voting module includes: a request receiving unit, a message responding unit, and a master approving unit.

The request receiving unit is configured to receive a request for being a new master sent by a state machine associated with other database.

The message responding unit is configured to respond with an approval message if data amount of to-be-updated events in the other database is greater than or equal to data amount of to-be-updated events in the local database, or otherwise responding with a disapproval message.

The master approving unit is configured to use a database obtaining a highest number of approval messages as the new master.

### The Sixth Embodiment

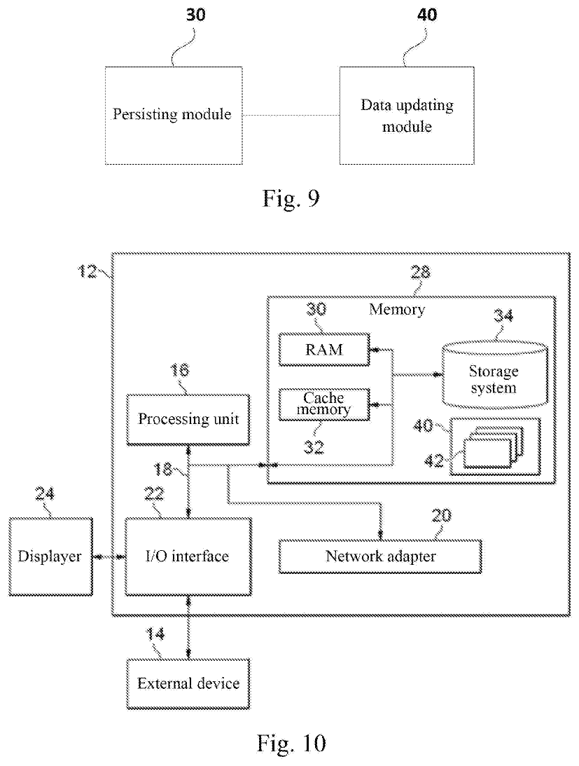

FIG. 9 is a schematic structural diagram of an apparatus for data updating provided in the sixth embodiment of the present disclosure. Referring to FIG. 9, the apparatus for updating data provided in the present embodiment includes: a persisting module 30 and a data updating module 40.

The persisting module 30 is configured to store a received to-be-updated event in a local disk or hard disk.

The data updating module 40 is configured to update data on a local database based on the received to-be-updated event if receiving an update instruction issued by a master.

The technical solutions of the embodiments of the present disclosure store a received to-be-updated event in a local disk or hard disk, thereby achieving persistence of the to-be-updated event, and avoiding data loss of the to-be-updated event resulted from device shutdown or restart. Furthermore, after receiving an update instruction issued by a master, data updating on a local database is performed based on the received to-be-updated event, thereby achieving synchronous data updating with the master.

Further, the apparatus further includes: an event updating module or an event deleting module.

The event updating module is configured to control, before updating data on a local database based on the received to-be-updated event if receiving an update instruction issued by a master, the local database to perform updating and event committing based on the to-be-updated event if partition or failure of the master occurs, and the local database is a voted candidate master; and switching the local database to a new master.

The event deleting module is configured to compare with to-be-updated events in the new master to delete more to-be-updated events than to-be-updated events in the new master if partition or failure of the master occurs, and the local database is still a slave after voting.

### The Seventh Embodiment

FIG. 10 is a schematic structural diagram of an apparatus provided in the seventh embodiment of the present disclosure. FIG. 10 shows a block diagram of an exemplary device 12 adapted to implement the embodiments of the present disclosure. The device 12 shown in FIG. 10 is merely an example, and should not limit the functions and scope of use of the embodiments of the present disclosure.

As shown in FIG. 10, the device 12 is expressed in the form of a general-purpose computing device. Components of the device 12 may include, but are not limited to: one or more processors or a processing unit 16, a system memory 28, and a bus 18 connecting different system components (including the system memory 28 and the processing unit 16).

The bus 18 represents one or more of a few bus structures, including a memory bus or a memory controller, a peripheral bus, a graphics acceleration port, a processor, or a local bus with any bus structure of a plurality of bus structures. For example, the system structures include, but are not limited to, an industrial standard architecture (ISA) bus, a micro channel architecture (MAC) bus, an enhanced ISA bus, a Video Electronics Standards Association (VESA) local bus, and a peripheral component interconnect (PCI) bus.

The device 12 typically includes a plurality of computer system readable media. These media may be any available medium that may be accessed by the device 12, including transitory media, non-transitory media, removable media and non-removable media.

The system memory 28 may include a computer system readable medium in the form of a transitory memory, such as a random-access memory (RAM) 30 and/or a cache memory 32. The device 12 may further include other removable/non-removable, and transitory/non-transitory computer system storage media. By way of example only, a storage system 34 can be used for reading from and writing in non-removable and non-transitory magnetic media (not shown in FIG. 10, generally known as a “hard drive”). A disk drive for reading from and writing in a removable non-transitory disk (such as a “floppy disk”) and an optical driver for reading from and writing in a removable non-volatile disk (such as CD-ROM, DVD-ROM, or other optical media) may be provided, though the disk drive or the optical driver is not shown in FIG. 10. Under the circumstances, each drive may be connected to the bus 18 through one or more data media interfaces. The memory 28 may include at least one program product, the program product has a set of (e.g., at least one) program modules, and the program modules are configured to execute the functions of the embodiments of the present disclosure.

A program/utility software 40 with a set of (at least one) program modules 42 may be stored in, e.g., the memory 28. Such a program module 42 includes, but is not limited to, an operating system, one or more application programs, other program modules, and program data. Each of these examples or a combination thereof may include implementation of a network environment. The program module 42 usually executes the functions and/or methods in the embodiments according to the present disclosure.

The device 12 may also communicate with one or more external devices 14 (e.g., a keyboard, a pointing device, and a displayer 24), and may also communicate with one or more devices that cause a user to interact with the device 12, and/or communicates with any device (e.g., a network card and a modem) that causes the device 12 to communicate with one or more of other computing devices. Such communication may be performed through an input/output (I/O) interface 22. Moreover, the device 12 may further communicate with one or more networks (e.g., a local area network (LAN), a wide area network (WAN), and/or a public network such as the Internet) through a network adapter 20. As shown in the figure, the network adapter 20 communicates with other modules of the device 12 through the bus 18. It should be appreciated that other hardware and/or software modules may be used in combination with the device 12, including but not limited to: a microcode, a device driver, a redundancy processing unit, an external disk drive array, a RAID system, a tape drive, and a data backup storage system, though the modules are not shown in the figure.

The processing unit 16 executes various functional applications and data processing by running a program stored in the system memory 28, such as implementing the method for updating data provided in the embodiments of the present disclosure.

### The Eighth Embodiment

The eighth embodiment of the present disclosure further provides a computer readable storage medium, storing a computer program thereon, where the program, when executed by a processor, implements the method for updating data according to any one of the embodiments of the present disclosure.

The computer storage medium of the embodiments of the present disclosure may use any combination of one or more computer readable media. The computer readable medium may be a computer readable signal medium or a computer readable storage medium. An example of the computer readable storage medium may include, but is not limited to: an electric, magnetic, optical, electromagnetic, infrared, or semiconductor system, apparatus, element, or a combination of any of the above. A more specific example (non-enumerated list) of the computer readable storage medium may include, but is not limited to: electrical connection with one or more wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. Herein, the computer readable storage medium may be any tangible medium containing or storing programs which may be used by a command execution system, apparatus, or element or incorporated thereto.

The computer readable signal medium may include data signal in the base band or propagating as a part of a carrier wave, in which computer readable program codes are carried. The propagating data signal may take various forms, including but not limited to: an electromagnetic signal, an optical signal or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element.

The program codes contained on the computer readable medium may be transmitted with any suitable medium, including but not limited to: wireless, wired, optical cable, RF medium, etc., or any suitable combination of the above.

A computer program code for executing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

It should be noted that, the above description only provides preferred embodiments of the present disclosure and the employed technical principles. It should be appreciated by those skilled in the art that the present disclosure is not limited to the particular embodiments described herein. Those skilled in the art may make various obvious changes, readjustments, and replacements without departing from the scope of protection of the present disclosure. Therefore, while the present disclosure is illustrated in detail in combination with the above embodiments, the present disclosure is not only limited to the above embodiments, and can further include more other equivalent embodiments without departing from the concept of the present disclosure. The scope of the present disclosure is defined by the scope of the appended claims.

What is claimed is:

1. A method for updating data, comprising:
sending a to-be-updated event to at least one slave; and
controlling a local database to update the to-be-updated event, and synchronously issuing an update instruction to the at least one slave, the update instruction instructing the at least one slave to synchronously update the received to-be-updated event.

2. The method according to claim 1, wherein the sending a to-be-updated event to at least one slave comprises:
acquiring the to-be-updated event from a master work thread in a same progress via a master service thread by shared memory, and sending the to-be-updated event to the at least one slave via the master service thread.

3. The method according to claim 1, wherein a trigger condition of the controlling a local database to update the to-be-updated event, and synchronously issuing an update instruction to the at least one slave is:
a number of received receipt acknowledgment messages is greater than a set acknowledgment threshold, wherein each slave returns a receipt acknowledgment message after receiving the to-be-updated event.

4. The method according to claim 1, wherein before the controlling a local database to update the to-be-updated event, and synchronously issuing an update instruction to the at least one slave, the method further comprises:
rolling back the to-be-updated event if detecting partition or failure of the local database.

5. The method according to claim 1, wherein the method further comprises:
generating a master offline message via a master service thread based on a new master voted by a local state machine, and offlining the master via a master work thread based on the master offline message.

6. The method according to claim 5, wherein a state machine voting for a new master comprises:
receiving a request for being a new master sent by a state machine associated with other database;
responding with an approval message if data amount of to-be-updated events in the other database is greater than or equal to data amount of to-be-updated events in the local database, or otherwise responding with a disapproval message; and
using a database obtaining a highest number of approval messages as the new master.

7. A method for updating data, comprising:
storing a received to-be-updated event in a local disk or hard disk; and
updating data on a local database based on the received to-be-updated event if receiving an update instruction issued by a master.

8. The method according to claim 7, wherein before the updating data on a local database based on the received to-be-updated event if receiving an update instruction issued by a master, the method further comprises:
controlling the local database to perform updating and event committing based on the to-be-updated event if partition or failure of the master occurs, and the local database is a voted candidate master; and switching the local database to a new master; or
comparing with to-be-updated events in the new master to delete more to-be-updated events than to-be-updated events in the new master if partition or failure of the master occurs, and the local database is still a slave after voting.

9. An apparatus for updating data, comprising:
at least one processor; and
a memory storing instructions, wherein the instructions when executed by the at least one processor, cause the at least one processor to perform operations, the operations comprising:
sending a to-be-updated event to at least one slave; and
controlling a local database to update the to-be-updated event, and synchronously issuing an update instruction to the at least one slave, the update instruction instructing the at least one slave to synchronously update the received to-be-updated event.

10. The apparatus according to claim 9, wherein the sending a to-be-updated event to at least one slave comprises:
acquiring the to-be-updated event from a master work thread in a same progress via a master service thread by shared memory, and sending the to-be-updated event to the at least one slave via the master service thread.

11. The apparatus according to claim 9, wherein a trigger condition of the controlling a local database to update the to-be-updated event, and synchronously issuing an update instruction to the at least one slave is:
a number of received receipt acknowledgment messages is greater than a set acknowledgment threshold, wherein each slave returns a receipt acknowledgment message after receiving the to-be-updated event.

12. The apparatus according to claim 9, wherein before the controlling a local database to update the to-be-updated event, and synchronously issuing an update instruction to the at least one slave, the operations further comprise:
rolling back the to-be-updated event if detecting partition or failure of the local database before controlling the local database to update the to-be-updated event, and synchronously issuing the update instruction to the at least one slave.

13. The apparatus according to claim 9, wherein the operations further comprise:
generating a master offline message via a master service thread based on a new master voted by a local state machine, and offlining the master via a master work thread based on the master offline message.

14. The apparatus according to claim 13, wherein a state machine voting for a new master comprises:
receiving a request for being a new master sent by a state machine associated with other database;
responding with an approval message if data amount of to-be-updated events in the other database is greater than or equal to data amount of to-be-updated events in the local database, or otherwise responding with a disapproval message; and
using a database obtaining a highest number of approval messages as the new master.

15. An apparatus for updating data, comprising:
at least one processor; and
a memory storing instructions, wherein the instructions when executed by the at least one processor, cause the at least one processor to perform operations, the operations comprising:
storing a received to-be-updated event in a local disk or hard disk; and
updating data on a local database based on the received to-be-updated event if receiving an update instruction issued by a master.

16. The apparatus according to claim 15, wherein before the updating data on a local database based on the received to-be-updated event if receiving an update instruction issued by a master, the operations further comprises:
controlling, before updating data on the local database based on the received to-be-updated event if receiving the update instruction issued by the master, the local database to perform updating and event committing based on the to-be-updated event if partition or failure of the master occurs, and the local database is a voted candidate master; and switching the local database to a new master; or
comparing with to-be-updated events in the new master to delete more to-be-updated events than to-be-updated events in the new master if partition or failure of the master occurs, and the local database is still a slave after voting.

17. A non-transitory computer readable storage medium, storing a computer program thereon, wherein the program, when executed by a processor, causes the processor to perform operations, the operations comprising:
sending a to-be-updated event to at least one slave; and
controlling a local database to update the to-be-updated event, and synchronously issuing an update instruction to the at least one slave, the update instruction instructing the at least one slave to synchronously update the received to-be-updated event.

18. A non-transitory computer readable storage medium, storing a computer program thereon, wherein the program, when executed by a processor, causes the processor to perform operations, the operations comprising:
storing a received to-be-updated event in a local disk or hard disk; and
updating data on a local database based on the received to-be-updated event if receiving an update instruction issued by a master.
